(19) United States
(12) Patent Application Publication
(10) Pub. No.: US 2025/0240255 A1
(43) Pub. Date: Jul. 24, 2025

(54) PREDICTIVE OR PREEMPTIVE MACHINE LEARNING (ML) -DRIVEN OPTIMIZATION OF INTERNET PROTOCOL (IP) -BASED COMMUNICATIONS SERVICE

(71) Applicant: Level 3 Communications, LLC, Denver, CO (US)

(72) Inventor: Adam UZELAC, Rochester, NY (US)

(73) Assignee: Level 3 Communications, LLC, Denver, CO (US)

(21) Appl. No.: 19/013,769

(22) Filed: Jan. 8, 2025

Related U.S. Application Data
(60) Provisional application No. 63/623,593, filed on Jan. 22, 2024.

(51) Int. Cl. H04L 47/83; G06N 20/00; H04L 43/0876; H04L 65/403

(52) U.S. Cl. CPC H04L 47/83; G06N 20/00; H04L 43/0876; H04L 65/403

(57) ABSTRACT

Novel tools and techniques are provided for implementing predictive or preemptive machine learning (“ML”)-driven optimization of Internet protocol (“IP”)-based communications services. In various embodiments, a computing system may predict future provisioning demands for an IP-based communications system based on at least one of analysis of past IP-based communications patterns, analysis of current network condition data and current event data, and/or one or more trigger events, in some cases using a first ML model. The computing system may identify first (e.g., optimized) resource allocation based on the predicted future provisioning demands for the IP-based communications system, in some cases using a second ML model. The computing system may initiate changes in allocation of network resources for the IP-based communications system based on the identified first resource allocation, by performing at least one of routing or re-routing network traffic, load balancing, and/or adding, reassigning, and/or removing network resources.

### CROSS-REFERENCE TO RELATED APPLICATIONS

This application claims the benefit of U.S. Provisional Application No. 63/623,593 filed 22 Jan. 2024, entitled “Predictive or Preemptive Machine Learning (ML)-Driven Optimization of Internet Protocol (IP)-based Communications Services,” which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing provisioning of Internet protocol (“IP”)-based communications (including voice over Internet Protocol (“VoIP”) services and unified communications and collaboration (“UC&C”) communications services), and, more particularly, to methods, systems, and apparatuses for implementing predictive or preemptive machine learning (“ML”)-driven optimization of IP-based communications services.

### BACKGROUND

Typically, provisioning of VoIP services or UC&C communications services is a reactive process particularly when encountering network events, trigger events, and/or current events. As a result, disruption of such services and other network contention or performance reducing effects may occur due to such events. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing predictive or preemptive ML-driven optimization of IP-based communications services, in accordance with various embodiments.

FIG. 2 depicts an example sequence flow for implementing predictive or preemptive ML-driven optimization of IP-based communications services, in accordance with various embodiments.

FIG. 3 depicts a flow diagram illustrating an example method for implementing predictive or preemptive ML-driven optimization of IP-based communications services, in accordance with various embodiments.

FIGS. 4A-4C depict flow diagrams illustrating another example method for implementing predictive or preemptive ML-driven optimization of IP-based communications services, in accordance with various embodiments.

FIG. 5 depicts a block diagram illustrating an exemplary computer or system hardware architecture, in accordance with various embodiments.

### DETAILED DESCRIPTION OF CERTAIN EMBODIMENTS

### Overview

In various embodiments, a computing system may predict future provisioning demands for an Internet protocol (“IP”)-based communications system based on analysis of past IP-based communications patterns and based on at least one of one or more trigger events or analysis of current network condition data and current event data, in some cases using a first machine learning (“ML”) model. The computing system may identify first (e.g., optimized) resource allocation based on the predicted future provisioning demands for the IP-based communications system, in some cases using a second ML model. The computing system may initiate changes in allocation of network resources for the IP-based communications system based on the identified first resource allocation, by performing at least one of instructing mobilization of more network resources in one or more first locations, instructing reassignment of network resources in one or more second locations, instructing reduction of network resources in one or more third locations, adapting network routing, changing IP-based communications routing, or implementing load balancing of network resources.

In this manner, the system is able to anticipate or predict network issues before they can occur, and to initiate changes to allocation of network resources and/or to reroute network traffic to mitigate or avoid the anticipated or predicted network issues. The ML model is refined and updated to continually improve on the analysis of data to improve prediction and/or identification of trigger events and potential issues while improving identification of future provisioning demands. As a result, network operations and efficiency in provisioning of the IP-based communications services may be improved.

These and other aspects of the predictive or preemptive ML-driven optimization of IP-based communications services (including VoIP services, UC&C platform services, etc.) are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method including predicting, by a computing system, future provisioning demands for an IP-based communications system based on analysis of past IP-based communications patterns and based on at least one of one or more trigger events or analysis of current network condition data and current event data; identifying, by the computing system, first (e.g., optimized) resource allocation based on the predicted future provisioning demands for the IP-based communications system; and initiating, by the computing system, changes in allocation of network resources for the IP-based communications system based on the identified first resource allocation, by performing at least one of instructing mobilization of more network resources in one or more first locations, instructing reassignment of network resources in one or more second locations, instructing reduction of network resources in one or more third locations, adapting network routing, changing IP-based communications routing, or implementing load balancing of network resources.

In another aspect, the technology relates to a system including a processing system and memory coupled to the processing system. The memory includes computer executable instructions that, when executed by the processing system, causes the system to perform operations including: monitoring or collecting current network condition data and current event data; identifying past IP-based communications patterns for an IP-based communications system based on analysis of historical network data and historical event data; predicting future provisioning demands for the IP-based communications system based on analysis of the past IP-based communications patterns and based on analysis of current network condition data and current event data; determining whether the predicted future IP-based communications patterns necessitate changes to network resource provisioning; and based on a determination that the predicted future IP-based communications patterns necessitate changes to network resource provisioning, performing the following tasks: identifying first resource allocation based on the predicted future provisioning demands for the IP-based communications system; and initiating changes in allocation of network resources for the IP-based communications system based on the identified first resource allocation.

In yet another aspect, the technology relates to a method including monitoring or collecting, by a computing system, current network condition data and current event data; predicting, by the computing system and using a first ML model, future provisioning demands for an IP-based communications system based on analysis of past IP-based communications patterns and based on analysis of current network condition data and current event data; identifying, by the computing system and using a second ML model, first resource allocation based on the predicted future provisioning demands for the IP-based communications system; and initiating, by the computing system, changes in allocation of network resources for the IP-based communications system based on the identified first resource allocation.

Various modifications and additions can be made to the embodiments discussed without departing from the scope of the invention. For example, while the embodiments described above refer to particular features, the scope of this invention also includes embodiments having different combination of features and embodiments that do not include all of the above-described features.

### Specific Exemplary Embodiments

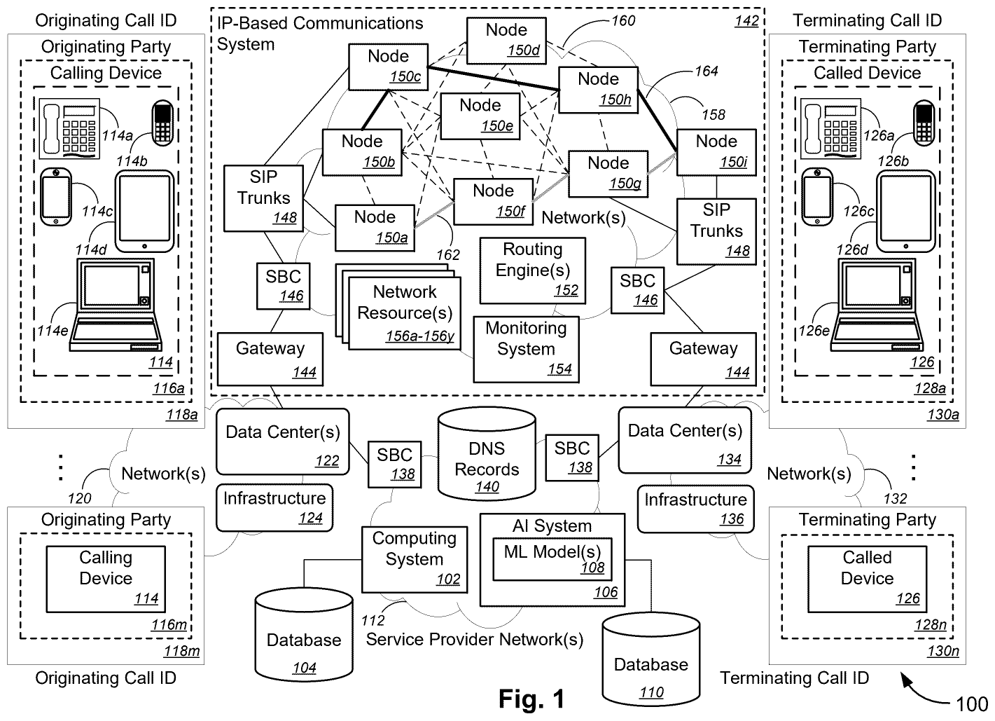

We now turn to the embodiments as illustrated by the drawings. FIGS. 1-5 illustrate some of the features of the method, system, and apparatus for implementing provisioning of Internet protocol (“IP”)-based communications (including voice over Internet Protocol (“VoIP”) services), and, more particularly, to methods, systems, and apparatuses for implementing predictive or preemptive machine learning (“ML”)-driven optimization of IP-based communications services, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

With reference to the figures, FIG. 1 depicts an example system 100 for implementing predictive or preemptive ML-driven optimization of IP-based communications services, in accordance with various embodiments.

In the non-limiting embodiment of FIG. 1, system 100 includes computing system 102 and corresponding database 104, artificial intelligence (“AI”) system 106 utilizing one or more ML models 108, and AI or ML database 110, each located or disposed within one or more service provider networks 112. System 100 may further include a calling device 114 that is associated with an originating party 116a among a plurality of originating parties 116a-116m (collectively, “originating parties 116,” “calling parties 116,” or “users 116,” or the like) at corresponding originating addresses or originating call identifiers (“IDs”) 118a-118m (collectively, “source addresses 118” or “call IDs 118” or the like) in an originating network(s) 120. In some instances, the calling device 114 (also referred to as a “user device 114” or the like) may include, but is not limited to, at least one of a telephone 114a, a mobile phone 114b, a smart phone 114c, a tablet computer 114d, or a laptop computer 114e, and/or the like. System 100 likewise may include a called device 126 that is associated with a terminating party 128a among a plurality of terminating parties 128a-128n (collectively, “terminating parties 128,” “called parties 128,” or “users 128,” or the like) at corresponding terminating addresses or terminating call IDs 130a-130n (collectively, “terminating addresses 130” or “call IDs 130” or the like) in a terminating network(s) 132. In some instances, the called device 126 (also referred to as a “user device 126” or the like), similar to calling device 114, may include, but is not limited to, at least one of a telephone 126a, a mobile phone 126b, a smart phone 126c, a tablet computer 126d, or a laptop computer 126c, and/or the like. In examples, the call IDs 118 and 130 may each include one of a telephone number associated with a particular user, a unique user ID that is associated with the particular user for call connection purposes, or a unique network ID that is associated with the particular user for call connection purposes, and/or the like.

System 100 further includes data center(s) 122 and network infrastructure 124 that are located or disposed within network(s) 120, or that are otherwise associated with a first service provider that operates or manages network(s) 120. System 100 further includes data center(s) 134 and network infrastructure 136 that are located or disposed within network(s) 132, or that are otherwise associated with a second service provider that operates or manages network(s) 132. In examples, system 100 may further include one or more session border controllers (“SBCs”) 138 and at least one domain name system (“DNS”) records database 140, each located or disposed within service provider network(s) 112. In some examples, data center(s) 122 or 134 (or device(s) 114 or 126 via data center(s) 122, or 134, respectively) may communicatively couple with DNS records database 140, via corresponding SBC(s) 138.

In examples, system 100 further includes an IP-based communications system 142. In some embodiments, the IP-based communications system 142 may include one or more gateway devices 144, one or more SBCs 146, one or more session initiation protocol (“SIP”) trunks 148, a plurality of nodes 150a-150i (collectively, “nodes 150” or the like) s, routing engine(s) 152, monitoring system 154, and one or more network resources 156a-156y (collectively, “network resources 156” or the like), two or more of which are located or disposed within network(s) 158. In examples, the plurality of nodes 150 may be interconnected with each other, as denoted by dashed lines 160 in FIG. 1. Herein, m, n, and y are non-negative integer numbers that may be either all the same as each other, all different from each other, or some combination of same and different (e.g., one set of two or more having the same values with the others having different values, a plurality of sets of two or more having the same value with the others having different values, etc.).

In examples, computing system 102 includes at least one of an orchestrator, an AI system, an IP-based communications management system, a server, a cloud computing system, or a distributed computing system, and/or the like. In some examples, the IP-based communications system may include at least one of a voice over Internet Protocol (“VoIP”) communications system, an IP-based video communications system, or a unified communications and collaboration (“UC&C”) communications system, and/or the like. In some examples, the UC&C communications system includes two or more of a voice service platform, a VoIP platform, an email platform, an instant messaging or chat platform, a collaboration facilitator platform, a web conferencing platform, an audio conferencing platform, or a video conferencing platform, and/or the like.

Although FIG. 1 depicts calling devices 114 located at originating network(s) 120 and called devices 126 located at terminating network(s) 132, this is merely for purposes of illustration, and, at any one time, network 126 and 132 may have either or both calling devices 114 and called devices 126, and may accordingly originate or terminate calls via the IP-based communications system 142. In some examples, two or more of the first service provider operating or managing network(s) 120, the second service provider operating or managing network(s) 132, the service provider operating or managing service provider network(s) 112, or the service provider operating or managing network(s) 158 may be the same service provider.

In some embodiments, networks 112, 120, 132, and 158 may each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a PSTN; an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the networks 112, 120, 132, and 158 may include an access network of the service provider (e.g., an Internet service provider (“ISP”)). In another embodiment, the networks 112, 120, 132, and 158 may include a core network of the service provider and/or the Internet.

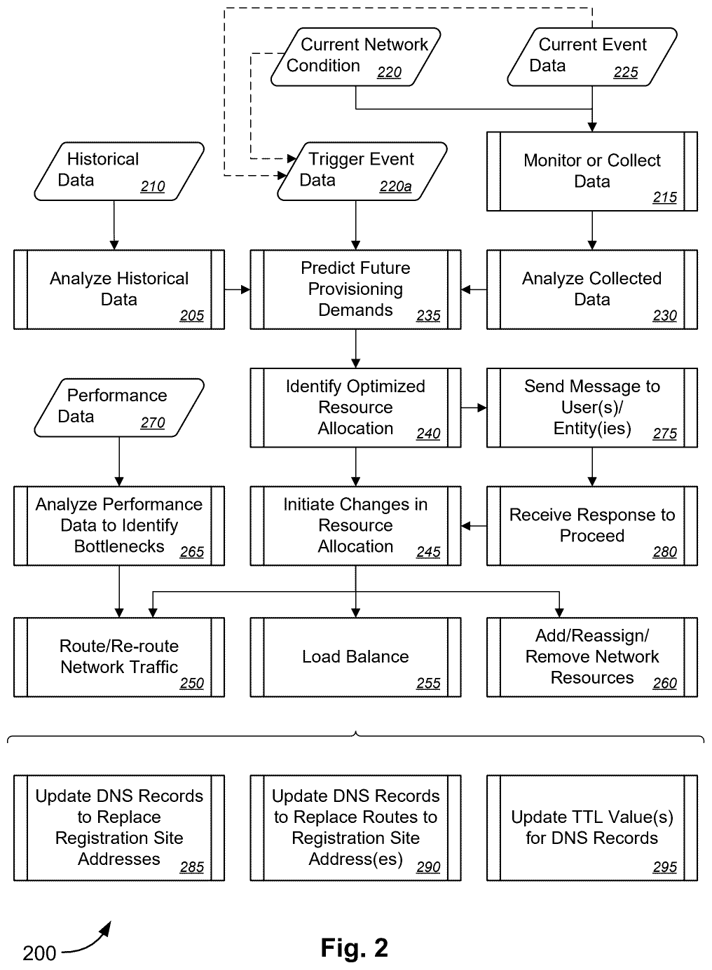

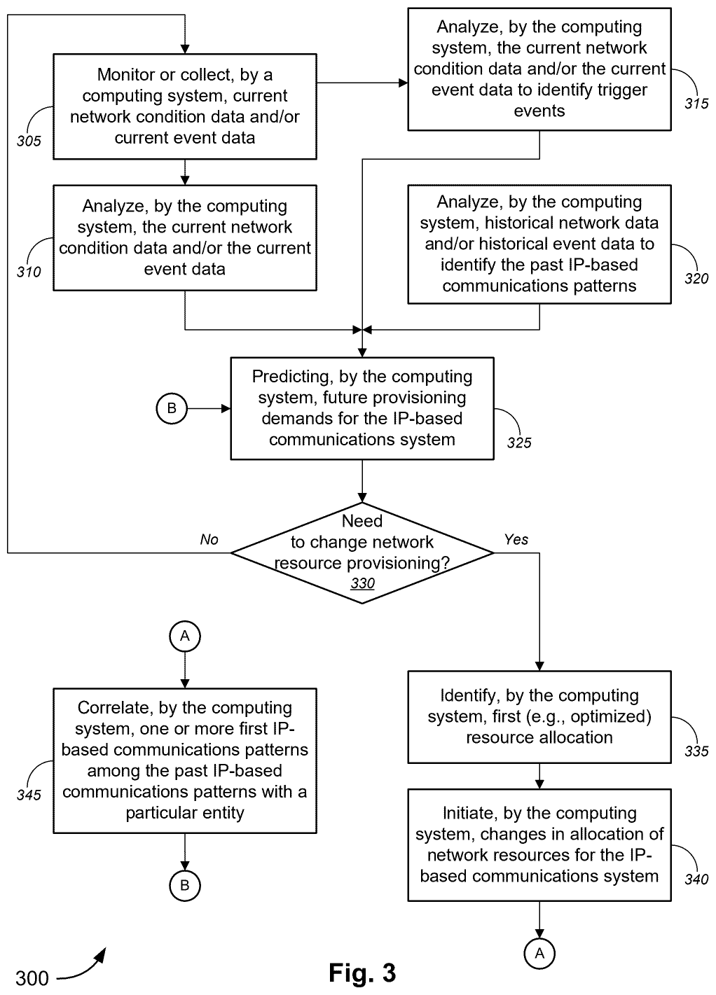

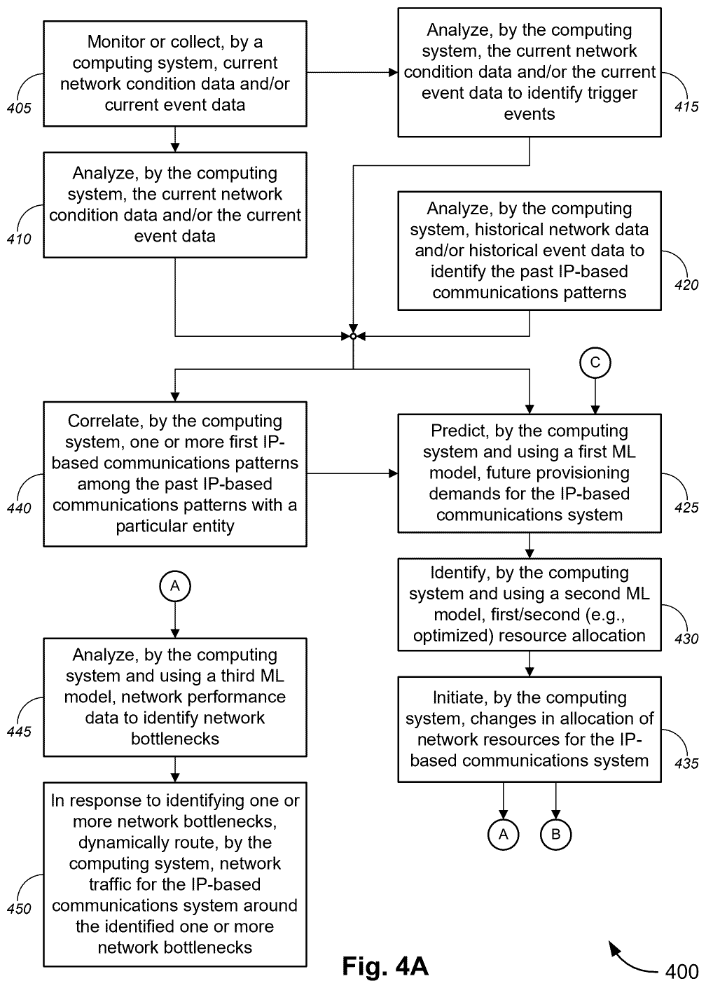

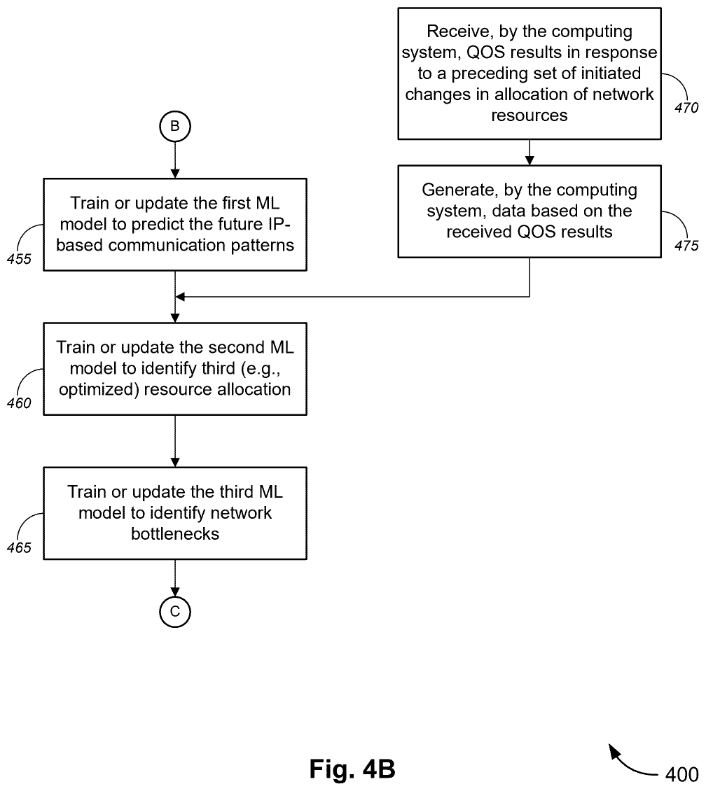

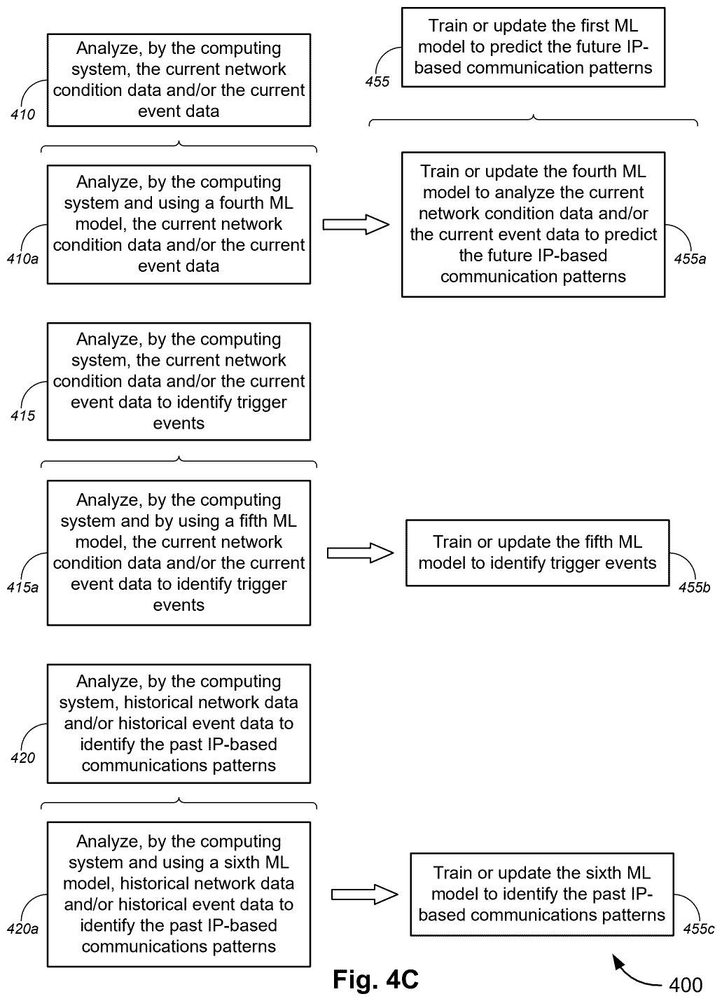

In operation, computing system 102 and/or AI system 106 may perform methods for implementing predictive or preemptive ML-driven optimization of IP-based communications services, as described in detail below with respect to FIGS. 2-4. For example, sequence flows as described below with respect to FIG. 2, and methods as described in detail with respect to FIGS. 3 and 4A-4C may be applied with respect to the operations of system 100 of FIG. 1.

In an aspect, the computing system 102 and/or the AI system 106 may predict, in some cases using a first ML model among the one or more ML models 108, future provisioning demands for IP-based communications system 142 based on analysis of past IP-based communications patterns and based on at least one of one or more trigger events or analysis of current network condition data and current event data. The past IP-based communications patterns, which may be retrieved from database 104 or 110, may be analyzed based on historical data (e.g., historical network data and/or historical event data, as described in detail below) that may be stored and retrieved from database 104 or 110. The current network condition data and current event data may correspond to network conditions and current events, respectively, which, along with trigger events, may be monitored by monitoring system 154. The computing system 102 and/or the AI system 106 may identify, in some cases using the first ML model or a second ML model among the one or more ML models 108, an optimized resource allocation based on the predicted future provisioning demands for the IP-based communications system. The computing system 102 and/or the AI system 106 may initiate changes in allocation of network resources (e.g., network resources 156a-156y, or the like) for the IP-based communications system based on the identified optimized resource allocation, in some cases, by performing at least one of instructing mobilization of more network resources in one or more first locations, instructing reassignment of network resources in one or more second locations, instructing reduction of network resources in one or more third locations, adapting network routing, changing IP-based communications routing, or implementing load balancing of network resources, and/or the like.

For instance, in adapting network routing or changing IP-based communications routing, such as routing around identified actual or potential bottlenecks, the computing system 102 and/or AI system 106 may instruct routing engine(s) 152 to route traffic (e.g., call traffic, etc.) over an optimized path (e.g., bolded line path 164 from node 150b to node 150c to node 150h to node 150i in FIG. 1, or the like), instead of a previous path (e.g., grayed line path 162 from node 150a to node 150f to node 150g to node 150i in FIG. 1, or the like).

FIG. 2 depicts an example sequence flow 200 for implementing predictive or preemptive ML-driven optimization of IP-based communications services, in accordance with various embodiments.

With reference to the non-limiting example 200 of FIG. 2, at operation 205, a computing system may analyze historical data 210, including historical network data and/or historical event data, to identify past IP-based communications patterns. At operation 215, the computing system may monitor or collect current data, including current network condition data 220 and/or current event data 225. At operation 230, the computing system may analyze the collected data including at least one of the current network condition data 220 or the current event data 225. In some cases, trigger event data 220a may be derived from analysis of at least one of the current network condition data 220 or the current event data 225 (as denoted in FIG. 2 by the dash-lined arrows). At operation 235, the computing system may predict future provisioning demands for an IP-based communications system based on analysis of the identified past IP-based communications patterns (from operation 205) and based on at least one of one or more trigger events 220a or analysis of current network condition data 220 and/or current event data 225 (from operation 230), and/or the like. At operation 240, the computing system may identify an optimized resource allocation based on the predicted future provisioning demands for the IP-based communications system (from operation 235). At operation 245, the computing system may initiate changes in allocation of network resources for the IP-based communications system based on the identified optimized resource allocation (from operation 240). In some examples, the computing system initiates changes by performing at least one of: (a) routing or re-routing network traffic (at operation 250); (b) load balancing (at operation 255); or (c) adding, reassigning, and/or removing network resources (at operation 260); and/or the like.

In examples, the computing system may include at least one of an orchestrator, an AI system, an IP-based communications management system, a server, a cloud computing system, or a distributed computing system, and/or the like. In some instances, the IP-based communications system includes at least one of a VoIP communications system, an IP-based video communications system, or a UC&C communications system, and/or the like. In some cases, the UC&C communications system includes two or more of a voice service platform, a VoIP platform, an email platform, an instant messaging or chat platform, a collaboration facilitator platform, a web conferencing platform, an audio conferencing platform, or a video conferencing platform, and/or the like.

In some examples, the current network condition data 220 includes at least one of data collected by one or more network gateway devices, data collected from one or more soft switches, data collected from one or more SBCs, data collected from call detail records (“CDRs”), data collected from log files, or simple network management protocol (“SNMP”) data, and/or the like. In some cases, the current network condition data includes at least one of current network traffic data, current call volume data, current call routing data, current quality of service (“QOS”) data, and/or the like. In examples, the current event data 225 includes at least one of current network event data, current news data, current weather event data, current natural disaster alert data, current manmade emergency alert data, or current social event data, and/or the like. In some cases, the current network event data includes at least one of power outage data, fiber cut data, or communications line damage data, and/or the like. In some instances, the current social event data includes at least one of entity-wide call meeting invitation, entity-wide work from home alert, or entity-wide shelter at home alert, community-wide shelter at home alert, area wide sporting event alert, area wide concert alert, area wide dignitary visit alert, area wide parade alert, area wide holiday alert, area wide road condition alert, area wide power outage alert, area wide disaster alert, or area wide terrorist alert, and/or the like. In examples, the current network condition data 220 or the current network event data includes current trigger event data, which corresponds to one or more trigger events including at least one of a successful call event, an unsuccessful call event, or an abnormal call event. In some cases, an abnormal call event may include a call having an abnormal call duration (e.g., a 48 hour phone call or 3 second phone call, etc.).

In examples, the past IP-based communications patterns each includes at least one of network traffic patterns, call volume patterns, call routing patterns, or QOS change patterns, and/or the like. In some instances, the current network traffic data includes at least one of network congestion data, network failure data, network failover data, or unresponsive network node data, and/or the like. In some cases, the current QOS data includes at least one of latency data, jitter data, packet loss data, bit rate data, throughput data, transmission delay data, availability data, service response time data, signal-to-noise ratio (“SNR”) data, or loudness level data, and/or the like. In some examples, the future provisioning demands may include at least one of future VoIP call volumes, future VoIP call durations, future VoIP call destinations, future IP-based video call volumes, future IP-based video durations, future IP-based video destinations, future network traffic volume, future network peak traffic durations, or future network traffic concentrations, and/or the like.

In some embodiments, the computing system may analyze network performance data 270 to identify network bottlenecks (at operation 265). In response to identifying one or more network bottlenecks, the computing system may dynamically route network traffic for the IP-based communications system around the identified one or more network bottlenecks (at operation 250). In some examples, rather than initiating changes in resource allocation (at operation 245) immediately following identification of the optimized resource allocation (at operation 240), the computing system may send a message to a user(s) or entity(ies) (at operation 275) indicating that future provisioning demands have been predicted and that an optimized resource allocation has been identified, and to confirm whether the user(s) or entity(ies) would like to proceed with initiating changes in resource allocation based on the identified optimized resource allocation. At operation 280, the computing system may receive a response from the user(s) or entity(ies) to proceed, after which the computing system may initiate the changes in resource allocation (at operation 245).

According to some embodiments, initiating changes in allocation of network resources for the IP-based communications system (at operation 245), or more particularly load balancing (at operation 255) may include performing at least one of: (1) the computing system updating DNS records to replace one or more first registration site addresses with one or more second registration site addresses, to direct querying user devices to send session initiation protocol (“SIP”) registration requests to the one or more second registration site addresses, the one or more second registration site addresses each including one of an email address or an IP address (at operation 285); (2) updating, by the computing system, the DNS records to replace one or more first network routes to a third registration site address with one or more second network routes to the third registration site address, to direct querying user devices to send SIP registration requests over one of the one or more second network routes to the third registration site address (at operation 290); or (3) updating, by the computing system, a time-to-live (“TTL”) value for the DNS records to indicate how long the user devices should cache information obtained from the DNS records or to indicate how frequently to query the DNS records for registration site addresses or network routes (at operation 295) (e.g., low TTL value (e.g., 5 minutes or the like) indicates more frequent re-registration, while relatively high TTL value (e.g., 1 day, or the like) indicates fewer or less frequent re-registration, or the like); and/or the like.

Merely by way of example, in some cases, the analysis processes of operations 205, 230, and/or 265, the prediction process at operation 235, and/or the identification process at operation 240 may be performed using one or more ML models that have been trained and/or updated to perform the respective processes or tasks, such as described in detail below with respect to FIGS. 4A-4C.

In an aspect, large ML bots or a large number of ML bots may ingest and analyze past call patterns (e.g., via SNMP data, CDRs, logs, etc.). ML models may be built, trained, and/or updated using the resultant data. In some cases, metadata (e.g., corresponding to customer accounts, etc.) may be added. In some examples, macro-level network events and alarms—including historical event data (e.g., fiber cut occurred at a first particular date and time and corresponds to a particular network congestion or network failover event, power outage occurred at a second particular date and time and corresponds to another network event, etc.—may be overlaid over the ML models. The ML models may be used to optimize resource allocation, by analyzing past traffic patterns, to predict future call volumes, durations, and destinations, etc. In some examples, the system can optimize SBC, VoIP, and/or network resources in preparation for the predicted future call volumes, durations, and/or destinations, in some cases by mobilizing more network resources, by adapting or changing routing of data or network traffic, and/or the like. In examples, the system can change QOS resources in the cases where the network variables cannot be sufficiently changed to address the network contention, where two or more networks attempt to concurrently or simultaneously access the same network resource(s).

In some embodiments, the system proactively identifies potential quality issues. For instance, in response to holidays, disasters, etc., a company may send all employees home, which may likely cause the employees to enable call forwarding. The system may predict that the company's VoIP gateways may be overwhelmed as a result, and may send a message to the company or agents/representatives thereof regarding the same. In some instances, the system may also reroute traffic and/or may implement additional resources to accommodate the anticipated call forwarding, while reassigning or reallocating the resources that were previously devoted or assigned to the company's on-site VoIP systems. In another example, in response to a company scheduling an “all-hands” virtual meeting, the system may predict that parameters for the UC&C platforms may exceeded, and may notify the meeting organizer that the number of anticipated participants will exceed the UC&C platform's currently configured capacity, with options to temporarily expand the configured capacity. In yet another example, the system may provide troubleshooting assistance. For instance, in response to associated predictions, the system may generate and send messages such as: “There was a monster flood in your area . . . ”; “There is a power outage in your neighborhood . . . ”; “A potential shift in demand may overwhelm network A, so there is a need to reroute traffic to network B”; etc. In these scenarios, the association of seemingly unrelated events are correlated to a VoIP network quality situation. The system may enable user or endpoint management. In some cases, regression models may be trained based on past traffic patterns. In some instances, the system may adapt DNS records that the endpoints (e.g., user devices or calling/called devices) are using, to register if a specific access point is made unavailable. The system may create a list of recommendations to end users on how to use features or the network based on where and how they are or will be connected. In an example, in response to an associated prediction based on correlation of analysis of historical data with a particular user, the system may send a message such as “We notice that on the third Wednesday of the month, you log into work from an unsecured public library. We are going to enable advanced encryption, and will change the screensaver timeout from 10 minutes to 30 seconds. Please be attentive to people looking over your shoulder.”

FIG. 3 depicts a flow diagram illustrating an example method 300 for implementing predictive or preemptive ML-driven optimization of IP-based communications services, in accordance with various embodiments.

Referring to the non-limiting example of FIG. 3, method 300, at operation 305, may include monitoring or collecting, by a computing system, current network condition data and/or current event data (similar to the process at operation 215 of FIG. 2, or the like). At operation 310, method 300 may include analyzing, by the computing system, at least one of the current network condition data or the current event data (similar to the process at operation 230 of FIG. 2, or the like). In some cases, method 300 may further include, at operation 315, analyzing, by the computing system, at least one of the current network condition data or the current event data to identify the one or more trigger events. At operation 320, method 300 may include analyzing, by the computing system, at least one of historical network data or historical event data to identify the past IP-based communications patterns (similar to the process at operation 205 of FIG. 2, or the like).

At operation 325, method 300 may include predicting, by the computing system, future provisioning demands for an IP-based communications system based on analysis of past IP-based communications patterns and based on at least one of one or more trigger events or analysis of current network condition data and/or current event data (similar to the process at operation 235 of FIG. 2, or the like). Method 300 may further include determining whether the predicted future IP-based communications patterns necessitate changes to network resource provisioning (at operation 330). If not, method 300 returns to the process at operation 305. If so, method 300 continues onto the process at operation 335. At operation 335, method 300 may include identifying, by the computing system, first (e.g., optimized) resource allocation based on the predicted future provisioning demands for the IP-based communications system (similar to the process at operation 240 of FIG. 2, or the like). Method 300, at operation 340, may include initiating, by the computing system, changes in allocation of network resources for the IP-based communications system based on the identified first resource allocation (similar to the process at operation 245 of FIG. 2, or the like). In some examples, the computing system initiates changes by performing at least one of instructing mobilization of more network resources in one or more first locations, instructing reassignment of network resources in one or more second locations, instructing reduction of network resources in one or more third locations, adapting network routing, changing IP-based communications routing, or implementing load balancing of network resources, and/or the like.

In some examples, method 300 may continue onto the process at operation 345, following the circular marker denoted, “A.” At operation 345, method 300 may include correlating, by the computing system, one or more first IP-based communications patterns among the past IP-based communications patterns with a particular user or entity, in some cases, based on at least one of one or more telephone numbers, a trunk group, or a fully qualified domain name (“FQDN”) each associated with the particular user or entity, and/or the like. In some examples, the particular user or entity may include, without limitation, one of an individual, a group of individuals, a private company, a group of private companies, a public company, a group of public companies, an institution, a group of institutions, an association, a group of associations, a governmental agency, a group of governmental agencies, or any suitable entity or their agent(s), representative(s), owner(s), and/or stakeholder(s), or the like. Method 300 may then return to the processes at operations 325-340, following the circular marker denoted, “B.” In this iteration, predicting future provisioning demands (at operation 325) comprises predicting, by the computing system, future provisioning demands by the particular entity based on the one or more first IP-based communications patterns (from operation 345). Based on a determination that the predicted future provisioning demands (from operation 325) necessitate a change in network resource provisioning (at operation 330), identifying the first resource allocation (at operation 335) comprises identifying, by the computing system, second (e.g., optimized) resource allocation based on the predicted future provisioning demands by the particular entity. Similarly, initiating changes in allocation of network resources (at operation 340) comprises initiating, by the computing system, changes in allocation of network resources for the IP-based communications system for meeting the predicted future provisioning demands by the particular entity based on the identified second resource allocation.

In some examples, the analysis processes of operations 310, 315, and/or 320, the prediction process at operation 325, the identification process at operation 335, and/or the correlation process at operation 345 may be performed using one or more ML models that have been trained and/or updated to perform the respective processes or tasks, such as described in detail below with respect to FIGS. 4A-4C.

FIGS. 4A-4C (collectively, “FIG. 4”) depict flow diagrams illustrating another example method 400 for implementing predictive or preemptive ML-driven optimization of IP-based communications services, in accordance with various embodiments. Method 400 of FIG. 4A continues onto FIG. 4B following the circular marker denoted, “B,” and returns to FIG. 4A following the circular marker denoted, “C.”

With reference to the non-limiting example of FIG. 4A, method 400, at operation 405, may include monitoring or collecting, by a computing system, current network condition data and/or current event data (similar to the process at operation 305 of FIG. 3, or the like). At operation 410, method 400 may include analyzing, by the computing system, at least one of the current network condition data or the current event data (similar to the process at operation 310 of FIG. 3, or the like). In some cases, method 400 may further include, at operation 415, analyzing, by the computing system, at least one of the current network condition data or the current event data to identify the one or more trigger events (similar to the process at operation 315 of FIG. 3, or the like). At operation 420, method 400 may include analyzing, by the computing system, at least one of historical network data or historical event data to identify the past IP-based communications patterns (similar to the process at operation 320 of FIG. 3, or the like). Method 400 either continues onto the process at operation 425 or continues onto the process at operation 440 prior to proceeding to operation 425.

At operation 425, method 400 may include predicting, by the computing system and using a first ML model, future provisioning demands for an IP-based communications system based on analysis of past IP-based communications patterns (from operation 420), based on the identified one or more trigger events (from operation 415), and/or based on analysis of the current network condition data and/or current event data (from operation 410) (similar to the process at operation 325 of FIG. 3, or the like). At operation 430, method 400 may include identifying, by the computing system and using a second ML model, first (e.g., optimized) resource allocation based on the predicted future provisioning demands for the IP-based communications system (from operation 425) (similar to the process at operation 335 of FIG. 3, or the like). Method 400, at operation 435, may include initiating, by the computing system, changes in allocation of network resources for the IP-based communications system based on the identified first resource allocation (from operation 430) (similar to the process at operation 340 of FIG. 3, or the like). In some examples, the computing system initiates changes by performing at least one of instructing mobilization of more network resources in one or more first locations, instructing reassignment of network resources in one or more second locations, instructing reduction of network resources in one or more third locations, adapting network routing, changing IP-based communications routing, or implementing load balancing of network resources, and/or the like.

At operation 440, method 400 may include correlating, by the computing system, one or more first IP-based communications patterns among the past IP-based communications patterns with a particular user or entity, in some cases, based on at least one of one or more telephone numbers, a trunk group, or a FQDN each associated with the particular user or entity, and/or the like. In some examples, the particular user or entity may include, without limitation, one of an individual, a group of individuals, a private company, a group of private companies, a public company, a group of public companies, an institution, a group of institutions, an association, a group of associations, a governmental agency, a group of governmental agencies, or any suitable entity or their agent(s), representative(s), owner(s), and/or stakeholder(s), or the like. Method 400 may then return to the processes at operations 425-435. In this iteration, predicting future provisioning demands (at operation 425) comprises predicting, by the computing system and using the first ML model, future provisioning demands by the particular entity based on the one or more first IP-based communications patterns (from operation 440). Identifying the first resource allocation (at operation 430) comprises identifying, by the computing system and using the second ML model, second (e.g., optimized) resource allocation based on the predicted future provisioning demands by the particular entity. Similarly, initiating changes in allocation of network resources (at operation 435) comprises initiating, by the computing system, changes in allocation of network resources for the IP-based communications system for meeting the predicted future provisioning demands by the particular entity based on the identified second resource allocation.

In some examples, method 400 either may continue onto the process at operation 445, following the circular marker denoted, “A,” or may continue onto the process at operation 455 in FIG. 4B, following the circular marker denoted, “B,” before returning to FIG. 4A following the circular marker denoted, “C.”

At operation 445, following the circular marker denoted, “A,” method 400 may include analyzing, by the computing system and using a third ML model, network performance data to identify network bottlenecks. At operation 450, method 400 may include, in response to identifying one or more network bottlenecks, dynamically routing, by the computing system, network traffic for the IP-based communications system around the identified one or more network bottlenecks.

At operation 455 in FIG. 4B (following the circular marker denoted, “B,” in FIG. 4A), method 400 includes training or updating the first ML model to predict the future IP-based communication patterns based on analysis of past IP-based communications patterns and based on one or more trigger events that are identified from analysis of current network condition data and current event data. At operation 460, method 400 includes training or updating the second ML model to identify third (e.g., optimized) resource allocation based on the predicted future provisioning demands. In some embodiments, method 400 may further include receiving, by the computing system, QOS results in response to a preceding set of initiated changes in allocation of network resources (at operation 470); and generating, by the computing system, data based on the received QOS results (at operation 475). In some examples, the data may be stored in a ML data store (e.g., database 110 of FIG. 1, or the like) as metadata that is used by the second ML for training. In examples, training or updating the second ML model to identify the third resource allocation (at operation 460) may be further based on the data or metadata. At operation 465, method 400 may further include training or updating the third ML model to identify the network bottlenecks. According to some embodiments, two or more of the first ML model, the second ML model, or the third ML model are part of a single integrated ML model. Method 400 may return to the process at operation 425 in FIG. 4A following the circular marker denoted, “C.”

In examples, the analysis processes at operations 410-420 may be performed using ML models. For example, turning to the non-limiting example of FIG. 4C, analyzing the at least one of the current network condition data or the current event data (at operation 410) may comprise analyzing, by the computing system and using a fourth ML model, the at least one of the current network condition data or the current event data (at operation 410a). Similarly, analyzing at least one of the current network condition data or the current event data to identify the one or more trigger events (at operation 415) may comprise analyzing, by the computing system and using a fifth ML model, the at least one of the current network condition data or the current event data to identify the one or more trigger events (at operation 415a). Likewise, analyzing, by the computing system, at least one of historical network data or historical event data to identify the past IP-based communications patterns (at operation 420) may comprise analyzing, by the computing system and using a sixth ML model, the at least one of historical network data or historical event data to identify the past IP-based communications patterns (at operation 420a).

In some embodiments, training or updating the first ML model to predict the future IP-based communication patterns (at operation 455) may include at least one of: training or updating the fourth ML model to analyze the at least one of the current network condition data or the current event data to predict the future IP-based communication patterns (at operation 455a); training or updating the fifth ML model to identify the one or more trigger events (at operation 455b); or training or updating the sixth ML model to identify the past IP-based communications patterns (at operation 455c); and/or the like. According to some embodiments, two or more of the fourth ML model, the fifth ML model, or the sixth ML model are part of a single integrated ML model. In examples, two or more of the first ML model, the second ML model, the third ML model, the fourth ML model, the fifth ML model, or the sixth ML model are part of a single integrated ML model.

While the techniques and procedures in sequence flows or methods 200-400 are depicted and/or described in a certain order for purposes of illustration, it should be appreciated that certain procedures may be reordered and/or omitted within the scope of various embodiments. Moreover, while the sequence flows or methods 200-400 may be implemented by or with (and, in some cases, are described below with respect to) the system, example, or embodiment 100 of FIG. 1 (or components thereof), such methods may also be implemented using any suitable hardware (or software) implementation. Similarly, while the system, example, or embodiment 100 of FIG. 1 (or components thereof), can operate according to the sequence flows or methods 200-400 (e.g., by executing instructions embodied on a computer readable medium), the system, example, or embodiment 100 of FIG. 1 can also operate according to other modes of operation and/or perform other suitable procedures.

### Exemplary System and Hardware Implementation

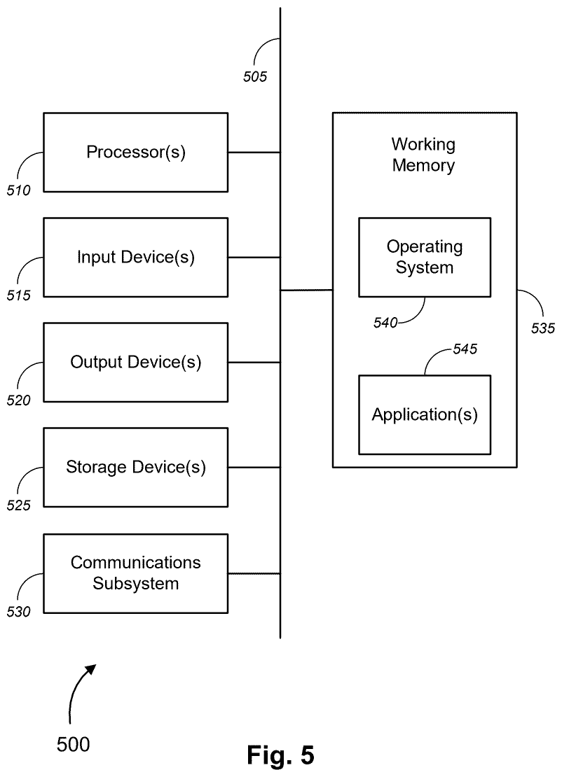

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., computing system 102, AI system 106, calling devices 114 and 114a-114e, called devices 126 and 126a-126e, SBCs 138 and 146, gateway devices 144, nodes 150a-150h, routing engine(s) 154, monitoring system 162, and network resources 164a-164y, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., computing system 102, AI system 106, calling devices 114 and 114a-114c, called devices 126 and 126a-126e, SBCs 138 and 146, gateway devices 144, nodes 150a-150h, routing engine(s) 154, monitoring system 162, and network resources 164a-164y, etc.), described above with respect to FIGS. 1-4-is shown including hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a Wi-Fi device, a WiMAX device, a wireless wide area network (“WWAN”) device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further include a working memory 535, which can include a RAM or ROM device, as described above.

The computer or hardware system 500 also may include software elements, shown as being currently located within the working memory 535, including an operating system 540, device drivers, executable libraries, and/or other code, such as one or more application programs 545, which may include computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that include the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with- or without-certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
predicting, by a computing system, future provisioning demands for an Internet protocol (“IP”)-based communications system based on analysis of past IP-based communications patterns and based on at least one of one or more trigger events or analysis of current network condition data and current event data;
identifying, by the computing system, first resource allocation based on the predicted future provisioning demands for the IP-based communications system; and
initiating, by the computing system, changes in allocation of network resources for the IP-based communications system based on the identified first resource allocation, by performing at least one of instructing mobilization of more network resources in one or more first locations, instructing reassignment of network resources in one or more second locations, instructing reduction of network resources in one or more third locations, adapting network routing, changing IP-based communications routing, or implementing load balancing of network resources.

2. The method of claim 1, wherein the IP-based communications system comprises at least one of a voice over Internet Protocol (“VoIP”) communications system, an IP-based video communications system, or a unified communications and collaboration (“UC&C”) communications system, wherein the UC&C communications system includes two or more of a voice service platform, a VoIP platform, an email platform, an instant messaging or chat platform, a collaboration facilitator platform, a web conferencing platform, an audio conferencing platform, or a video conferencing platform.

3. The method of claim 1, wherein the current network condition data includes at least one of current network traffic data, current call volume data, current call routing data, current quality of service (“QOS”) data, wherein the past IP-based communications patterns each includes at least one of network traffic patterns, call volume patterns, call routing patterns, or QOS change patterns, wherein the current network traffic data includes at least one of network congestion data, network failure data, network failover data, or unresponsive network node data, wherein the current QOS data includes at least one of latency data, jitter data, packet loss data, bit rate data, throughput data, transmission delay data, availability data, service response time data, signal-to-noise ratio (“SNR”) data, or loudness level data.

4. The method of claim 1, wherein the future provisioning demands include at least one of future VoIP call volumes, future VoIP call durations, future VoIP call destinations, future IP-based video call volumes, future IP-based video durations, future IP-based video destinations, future network traffic volume, future network peak traffic durations, or future network traffic concentrations.

5. The method of claim 1, wherein the current event data includes at least one of current network event data, current news data, current weather event data, current natural disaster alert data, current manmade emergency alert data, or current social event data, wherein the current network event data includes at least one of power outage data, fiber cut data, or communications line damage data, wherein the current social event data includes at least one of entity-wide call meeting invitation, entity-wide work from home alert, or entity-wide shelter at home alert, community-wide shelter at home alert, area wide sporting event alert, area wide concert alert, area wide dignitary visit alert, area wide parade alert, area wide holiday alert, area wide road condition alert, area wide power outage alert, area wide disaster alert, or area wide terrorist alert, wherein the current network condition data or the current network event data includes current trigger event data, which corresponds to one or more trigger events including at least one of a successful call event, an unsuccessful call event, or an abnormal call event.

6. The method of claim 5, further comprising:
monitoring or collecting, by the computing system, current network condition data and current event data, wherein the current network condition data includes at least one of data collected by one or more network gateway devices, data collected from one or more soft switches, data collected from one or more session border controllers (“SBCs”), data collected from call detail records (“CDRs”), data collected from log files, or simple network management protocol (“SNMP”) data; and
analyzing, by the computing system, at least one of the current network condition data or the current event data to identify the one or more trigger events.

7. The method of claim 1, further comprising performing at least one of:
analyzing, by the computing system, historical network data and historical event data to identify the past IP-based communications patterns; or
determining, by the computing system, whether the predicted future IP-based communications patterns necessitate changes to network resource provisioning.

8. The method of claim 1, further comprising:
training or updating a first machine learning (“ML”) model to predict the future IP-based communication patterns based on analysis of past IP-based communications patterns and based on one or more trigger events that are identified from analysis of current network condition data and current event data;
wherein predicting the future IP-based communications patterns comprises predicting, by the computing system and utilizing the first ML model, the future IP-based communication patterns based on analysis of past IP-based communications patterns and based on one or more trigger events that are identified from analysis of current network condition data and current event data.

9. The method of claim 8, further comprising:
training or updating a second ML model to identify second resource allocation based on the predicted future provisioning demands;
wherein identifying the first resource allocation comprises identifying, by the computing system and utilizing the second ML model, the second resource allocation based on the predicted future provisioning demands.

10. The method of claim 9, further comprising:
correlating, by the computing system, one or more first IP-based communications patterns among the past IP-based communications patterns with a particular entity based on at least one of one or more telephone numbers, a trunk group, or a fully qualified domain name (“FQDN”) each associated with the particular entity;
wherein predicting future provisioning demands comprises predicting, by the computing system and utilizing the first ML model, future provisioning demands by the particular entity based on the one or more first IP-based communications patterns;
wherein identifying the first resource allocation comprises identifying, by the computing system and utilizing the second ML model, third resource allocation based on the predicted future provisioning demands by the particular entity; and
wherein initiating changes in allocation of network resources comprises initiating, by the computing system, changes in allocation of network resources for the IP-based communications system for meeting the predicted future provisioning demands by the particular entity based on the identified third resource allocation.

11. The method of claim 9, further comprising:
receiving, by the computing system, QOS results in response to a preceding set of initiated changes in allocation of network resources; and
generating, by the computing system, data based on the received QOS results, wherein the data is stored in a ML data store as metadata that is used by the second ML for training;
wherein training or updating the second ML model to identify the second resource allocation is further based on the metadata.

12. The method of claim 1, further comprising:
analyzing, by the computing system and using a third ML model, network performance data to identify network bottlenecks; and
in response to identifying one or more network bottlenecks, dynamically routing, by the computing system, network traffic for the IP-based communications system around the identified one or more network bottlenecks.

13. The method of claim 1, wherein initiating changes in allocation of network resources for the IP-based communications system comprises performing at least one of:
updating, by the computing system, domain name system (“DNS”) records to replace one or more first registration site addresses with one or more second registration site addresses, to direct querying user devices to send session initiation protocol (“SIP”) registration requests to the one or more second registration site addresses, the one or more second registration site addresses each including one of an email address or an IP address;
updating, by the computing system, the DNS records to replace one or more first network routes to a third registration site address with one or more second network routes to the third registration site address, to direct querying user devices to send SIP registration requests over one of the one or more second network routes to the third registration site address; or
updating, by the computing system, a time-to-live (“TTL”) value for the DNS records to indicate how long the user devices should cache information obtained from the DNS records or to indicate how frequently to query the DNS records for registration site addresses or network routes.

14. A system, comprising:
a processing system; and
memory coupled to the processing system, the memory comprising computer executable instructions that, when executed by the processing system, causes the system to perform operations comprising:
monitoring or collecting current network condition data and current event data;
identifying past Internet protocol (“IP”)-based communications patterns for an IP-based communications system based on analysis of historical network data and historical event data;
predicting future provisioning demands for the IP-based communications system based on analysis of the past IP-based communications patterns and based on analysis of current network condition data and current event data;
determining whether the predicted future IP-based communications patterns necessitate changes to network resource provisioning; and
based on a determination that the predicted future IP-based communications patterns necessitate changes to network resource provisioning, performing the following tasks:
identifying first resource allocation based on the predicted future provisioning demands for the IP-based communications system; and
initiating changes in allocation of network resources for the IP-based communications system based on the identified first resource allocation.

15. The system of claim 14, wherein predicting future demands for the IP-based communications system further comprises analyzing network performance data to identify network bottlenecks, wherein identifying the first resource allocation further comprises identifying routes around the identified one or more network bottlenecks, wherein initiating the changes in allocation of network resources comprises dynamically routing network traffic for the IP-based communications system around the identified one or more network bottlenecks based on the identified routes.

16. The system of claim 14, wherein one or more machine learning (“ML”) models are used for at least one of identifying the past IP-based communications patterns, predicting the future provisioning demands, or identifying the first resource allocation.

17. A method, comprising:
monitoring or collecting, by a computing system, current network condition data and current event data;
predicting, by the computing system and using a first machine learning (“ML”) model, future provisioning demands for an Internet protocol (“IP”)-based communications system based on analysis of past IP-based communications patterns and based on analysis of current network condition data and current event data;
identifying, by the computing system and using a second ML model, first resource allocation based on the predicted future provisioning demands for the IP-based communications system; and
initiating, by the computing system, changes in allocation of network resources for the IP-based communications system based on the identified first resource allocation.

18. The method of claim 17, further comprising:
analyzing, by the computing system and using a third ML model, network performance data to identify network bottlenecks; and
in response to identifying one or more network bottlenecks, dynamically routing, by the computing system, network traffic for the IP-based communications system around the identified one or more network bottlenecks.

19. The method of claim 18, wherein two or more of the first ML model, the second ML model, or the third ML model are part of a single integrated fourth ML model.

20. The method of claim 17, further comprising:
receiving, by the computing system, QOS results in response to a preceding set of initiated changes in allocation of network resources;
generating, by the computing system, data based on the received QOS results, wherein the data is stored in a ML data store as metadata that is used by the second ML for training; and
training or updating the second ML model to identify a first resource allocation based on the predicted future provisioning demands and based on the metadata.
